(19) United States
(12) Patent Application Publication
(10) Pub. No.: US 2024/0031253 A1
(43) Pub. Date: Jan. 25, 2024

(54) METHOD FOR RADIO ACCESS NETWORK VISIBLE QUALITY OF EXPERIENCE MEASUREMENT OF DUAL CONNECTIVITY

(71) Applicant: ZTE CORPORATION, Shenzhen (CN)

(72) Inventors: Zhuang LIU, Shenzhen (CN); Dapeng LI, Shenzhen (CN); Yin GAO, Shenzhen (CN)

(73) Assignee: ZTE CORPORATION, Shenzhen (CN)

(21) Appl. No.: 18/472,307

(22) Filed: Sep. 22, 2023

Related U.S. Application Data
(63) Continuation of application No. PCT/CN21/84515, filed on Mar. 31, 2021.

(51) Int. Cl. H04L 41/5067; H04W 24/10

(52) U.S. Cl. CPC H04L 41/5067; H04W 24/10

(57) ABSTRACT

A wireless communication method for use in a master node is disclosed. The method comprises transmitting, to a wireless terminal, a message comprising quality of experience (QoE) information associated with at least one QoE report configured for at least one wireless network node.

This application is a continuation of PCT/CN2021/084515, filed Mar. 31, 2021, the content of which is incorporated herein by reference in its entirety.

### TECHNICAL FIELD

This document is directed generally to wireless communications.

### BACKGROUND

The quality of experience (QoE) is an application layer measurement configured by an operator and reported inside an application layer. The QoE configuration is delivered as a container to a user equipment (UE) and the UE collects QoE measurements results and reports the QoE measurement results to a QoE server as another container. The radio access network (RAN) node forwards the containers between the UE and the QoE server/measurement collection entity (MCE) in core network transparently. In other words, the RAN node cannot decode such QoE configuration container and QoE report container and the QoE configuration and the reports are not visible to the RAN node. Therefore, the RAN node may not be able to understand or make use of the QoE measurement results.

In the existing specification, dual connectivity (DC) may be supported by the RAN node. That is, a multiple reception/transmission (Rx/Tx) capable UE may be configured to utilize resources provided by two different RAN nodes (e.g., two different base stations). One RAN node acts as the master node (MN) and another RAN node acts as the secondary node (SN). The UE may connect with MN and SN, the MN and SN are connected via a network interface and at least the MN is connected to the core network. When the UE is connected to two RAN nodes, the RAN node could provide services with a better service quality if knowing the QoE measurement results. However, in the existing technology, the RAN node may not be able to understand or make use of the QoE measurement results.

### SUMMARY

This document relates to methods, systems, and devices for RAN visible QoE measurements, and in particular to methods, systems, and devices for RAN visible QoE measurements of the DC.

The present disclosure relates to a wireless communication method for use in a master node. The method comprises transmitting, to a wireless terminal, a message comprising quality of experience, QoE, information associated with at least one QoE report configured for at least one wireless network node.

Various embodiments may preferably implement the following features:

Preferably or in some embodiments, the QoE information comprises QoE report resource information comprising at least one of a radio bearer resource located at the master node or a radio bearer resource located at a secondary node connected to the wireless terminal.

Preferably or in some embodiments, the QoE information comprises QoE configuration information of the at least one QoE report, wherein the QoE configuration information comprises at least one of:
at least one QoE metric, associated with a subset of QoE data measured for the at least one QoE report,
at least one QoE value derived based on the at least one QoE metric;
at least one services type associated with the at least one QoE report; or
at least one measurement triggering configuration of the at least one QoE report.
Preferably or in some embodiments, the QoE information comprises QoE status indication information comprising one of:
a QoE activation indication of activating the at least one QoE report;
a QoE deactivation indication of deactivating the at least one QoE report,
a QoE suspend indication of suspending the at least one QoE report, or
a QoE resume indication of resuming the at least one QoE report.

Preferably or in some embodiments, the wireless communication method further comprises receiving, from a core network or an operations, administration and maintenance, OAM, function, at least one of a QoE allowed indication or a transparent QoE container configured by the core network or the OAM function for the wireless terminal.

Preferably or in some embodiments, the wireless communication method further comprises allocating QoE resource information comprising a radio bearer resource for the at least one QoE report, wherein the QoE information comprises the radio bearer resource for the at least one QoE report.

Preferably or in some embodiments, the wireless communication method further comprises transmitting, to a secondary node connected to the wireless terminal, a QoE resource request for the at least one QoE report, and receiving, from the secondary node, QoE resource information comprising a radio bearer resource which locates at the secondary node for the at least one QoE report, wherein the QoE information comprises the QoE resource information.

Preferably or in some embodiments, the wireless communication method further comprises transmitting, to a secondary node connected to the wireless terminal, a QoE activation indication, and receiving, from the secondary node, QoE configuration information comprised in the QoE information.

Preferably or in some embodiments, the wireless communication method further comprises receiving, from a core network or an OAM function, a deactivation request for at least one of a QoE configuration container of the wireless terminal or the at least one QoE report.

Preferably or in some embodiments, the wireless communication method further comprises transmitting, to a secondary node connected to the wireless terminal, a QoE modification request comprising a QoE deactivation indication for at least one of the QoE configuration container of the wireless terminal or the at least one QoE report.

Preferably or in some embodiments, the wireless communication method further comprises receiving, from a secondary node connected to the wireless terminal, a QoE modification required message comprising a QoE deactivation indication for at least one of a QoE configuration container of the wireless terminal or the at least one QoE report.

Preferably or in some embodiments, the wireless communication method further comprises transmitting, to a secondary node connected to the wireless terminal, a QoE modification request, wherein the QoE modification request comprises at least one of:
a QoE suspend indication for at least one of a QoE configuration container of the wireless terminal or the at least one QoE report, or
a QoE resume indication for at least one of the QoE configuration container of the wireless terminal or the at least one QoE report.

Preferably or in some embodiments, the wireless communication method further comprises receiving, from a secondary node connected to the wireless terminal, a QoE modification required message, wherein the QoE modification required message comprises at least one of:
a QoE suspend indication for at least one of a QoE configuration container of the wireless terminal or the at least one QoE report, or
a QoE resume indication for at least one of the QoE configuration container of the wireless terminal or the at least one QoE report.

Preferably or in some embodiments, the wireless communication method further comprises receiving, from the wireless terminal, the at least one QoE report.

Preferably or in some embodiments, the wireless communication method further comprises transmitting, to a secondary node connected to the wireless terminal, the at least one QoE report.

Preferably or in some embodiments, the wireless communication method further comprises receiving, from a secondary node connected to the wireless terminal, the at least one QoE report.

The present disclosure relates to a wireless communication method for use in a secondary node. The method comprises:
receiving, from a master node, a quality of experience, QoE, resource request for at least one QoE report, which is configured at a wireless terminal and for at least one wireless network node, and
transmitting, to the master node, QoE resource information comprising a radio bearer resource which locates at the secondary node and for the at least one QoE report,
wherein each of the master node and the secondary node is connected to the wireless terminal.
The present disclosure relates to a wireless communication method for use in a secondary node. The method comprises:
receiving, from a master node, a quality of experience, QoE, activation indication, and
transmitting, to the master node, QoE configuration information of at least one QoE report which is configured at a wireless terminal and for at least one wireless network node,
wherein each of the master node and the secondary node is connected to the wireless terminal.
The present disclosure relates to a wireless communication method for use in a secondary node. The method comprises:
receiving, from a master node, a quality of experience, QoE, modification request associated with at least one of a QoE configuration container of a wireless terminal or at least one QoE report which is configured at the wireless terminal and for at least one wireless network node, and
performing a modification operation associated with the at least one QoE report based on the QoE modification request,
wherein each of the master node and the secondary node is connected to the wireless terminal,
wherein the QoE modification request comprises at least one of:
a QoE deactivation indication,
a QoE suspend indication, or
a QoE resume indication.

The present disclosure relates to a wireless communication method for use in a secondary node. The method comprises:
transmitting, to a master node, a quality of experience, QoE, modification required message associated with at least one of a QoE configuration container of a wireless terminal or at least one QoE report which is configured at the wireless terminal and for at least one wireless network node, wherein each of the master node and the secondary node is connected to the wireless terminal,
wherein the QoE modification required message comprises at least one of:
a QoE deactivation indication,
a QoE suspend indication, or
a QoE resume indication.

The present disclosure relates to a wireless communication method for use in a secondary node. The method comprises:
receiving, from a wireless terminal or a master node, a least one quality of experience, QoE, report which is configured at the wireless terminal and for at least one wireless network node,
wherein each of the master node and the secondary node is connected to the wireless terminal.

Various embodiments may preferably implement the following feature:
Preferably or in some embodiments, the at least one QoE report is received from the wireless terminal and the method further comprises transmitting, to the master node, the at least one QoE report.

The present disclosure relates to master node. The master node comprises a communication unit, configured to transmit, to a wireless terminal, a message comprising QoE information associated with at least one quality of experience, QoE, report configured for at least one wireless network node.

Various embodiments may preferably implement the following feature:
Preferably or in some embodiments, the master node further comprises a processor configured to perform any of aforementioned wireless communication methods.

The present disclosure relates to a secondary node. The secondary node comprises:
a communication unit, configured to:
receive, from an MN, a quality of experience, QoE, resource request for at least one QoE report, which is configured at a wireless terminal and for at least one wireless network node, and
transmit, to the MN, QoE resource information comprising a radio bearer resource which locates at the secondary node and for the at least one QoE report,
wherein each of the master node and the secondary node is connected to the wireless terminal.

The present disclosure relates to relates to a secondary node. The secondary node comprises:
a communication unit, configured to
receive, from an MN, a quality of experience, QoE, activation indication and
transmit, to the master node, QoE configuration information of at least one QoE report which is configured at a wireless terminal and for at least one wireless network node,
wherein each of the master node and the secondary node is connected to the wireless terminal.

The present disclosure relates to relates to a secondary node. The secondary node comprises:
a communication unit, configured to receive, from an MN, a QoE modification request associated with at least one of a QoE configuration container of a wireless terminal or at least one QoE report which is configured at the wireless terminal and for at least one wireless network node, and
a processor, configured to perform a modification operation associated with the at least one QoE report based on the QoE modification request,
wherein each of the master node and the secondary node is connected to the wireless terminal,
wherein the QoE modification request comprises at least one of:
a QoE deactivation indication,
a QoE suspend indication, or
a QoE resume indication.

The present disclosure relates to relates to a secondary node. The secondary node comprises:
a communication unit, configured to transmit, to a master node, a quality of experience, QoE, modification required message associated with at least one of a QoE configuration container of a wireless terminal or at least one QoE report which is configured at the wireless terminal and for at least one wireless network node,
wherein each of the master node and the secondary node is connected to the wireless terminal,
wherein the QoE modification required message comprises at least one of:
a QoE deactivation indication,
a QoE suspend indication, or
a QoE resume indication.

The present disclosure relates to relates to a secondary node. The secondary node comprises:
a communication unit, configured to receive, from a wireless terminal or a master node, a least one quality of experience, QoE, report which is configured at the wireless terminal and for at least one wireless network node,
wherein each of the master node and the secondary node is connected to the wireless terminal.

Various embodiments may preferably implement the following feature:
Preferably or in some embodiments, the secondary node further comprises a processor configured to perform the any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF DRAWINGS

FIG. 1 shows a schematic diagram of a procedure according to an embodiment of the present disclosure.

FIG. 2 shows a schematic diagram of a procedure according to an embodiment of the present disclosure.

FIG. 3 shows a schematic diagram of a procedure according to an embodiment of the present disclosure.

FIG. 4 shows a schematic diagram of a procedure according to an embodiment of the present disclosure.

FIG. 5 shows a schematic diagram of a procedure according to an embodiment of the present disclosure.

FIG. 6 shows a schematic diagram of a procedure according to an embodiment of the present disclosure.

FIG. 7 shows a schematic diagram of a procedure according to an embodiment of the present disclosure.

FIG. 8 shows a schematic diagram of a procedure according to an embodiment of the present disclosure.

FIG. 9 shows a flowchart of a method according to an embodiment of the present disclosure.

FIG. 10 shows a flowchart of a method according to an embodiment of the present disclosure.

FIG. 11 shows a flowchart of a method according to an embodiment of the present disclosure.

FIG. 12 shows a flowchart of a method according to an embodiment of the present disclosure.

FIG. 13 shows a flowchart of a method according to an embodiment of the present disclosure.

FIG. 14 shows a flowchart of a method according to an embodiment of the present disclosure.

FIG. 15 shows an example of a schematic diagram of a wireless terminal according to an embodiment of the present disclosure.

FIG. 16 shows an example of a schematic diagram of a wireless network node according to an embodiment of the present disclosure.

### DETAILED DESCRIPTION

In order to understand the experience of end to end customers (e.g., throughput, data loss, latency, or what attracts attention of the operators), QoE measurements may be defined based on different applications and corresponding measurements take place at the application layer of the UE (e.g., the measurements of throughput, data loss, latency, . . . , etc.). The operators therefore can understand both the quality and the performance of the services based on the QoE measurements results.

However, the QoE measurements results provided by the UE could only be understood by the QoE measurement collection entity in the network (e.g., QoE server). Although QoE measurement results are beneficial for optimizing the RAN node on scheduling network resources to ensure the superior services quality. Especially when the UE is connected to two RAN nodes, knowing the QoE measurement results helps the RAN node to provide the service with the excellent service quality. In the existing technology, the QoE measurements (both configurations and results) are not visible to the RAN node and the RAN cannot understand or make use of QoE measurement results.

### Embodiment 1: QoE Activation Procedure (MN Configures Whole QoE Configuration)

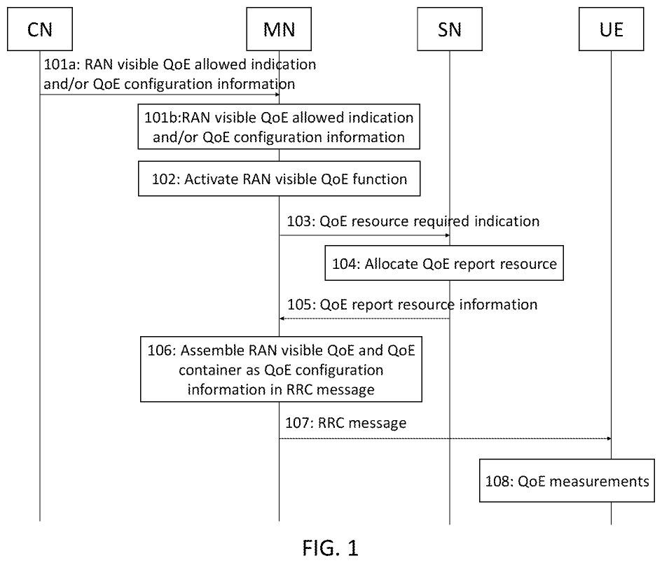

FIG. 1 shows a schematic diagram of a procedure according to an embodiment of the present disclosure. In FIG. 1, the UE is connected to a master node (MN) and a secondary node (SN), i.e., 2 RAN nodes or base stations (BSs). That is, the UE operates in the DC. The MN receives, from the core network (CN) (e.g., 5G core network (5GC)), an RAN visible QoE allowed indication and/or QoE configuration information for the UE. The RAN visible QoE allowed indication and/or the QoE configuration information may be transmitted within a next generation application protocol (NGAP) message, such as an initial context setup request, a protocol data unit (PDU) session setup request, a QoE activation request or a handover request message sent by the CN (Step 101a). As an alternative, the MN configures the RAN visible QoE allowed indication and/or the QoE configuration information by operations, administration and maintenance (OAM) for the UE (step 101b). Note that, the steps 101a and/or 101b may be optional.

In an embodiment, the QoE configuration information comprises at least one of the following information: a QoE configuration container, i.e. a coded container which is transparently forwarded by the RAN node between the UE and a QoE entity (e.g. a QoE server, the CN, or a measurement collection entity (MCE)) and is not visible by the RAN node; and a RAN visible QoE configuration, which is visible by the RAN node.

In an embodiment, the QoE configuration container comprises at least one of the following information: a QoE metric defining a subset of QoE measured data collected from the UE (e.g. packet Round-trip time, jitter duration time, throughput, . . . , etc.); QoE values defining define a subset of QoE values derived from the QoE metrics data (e.g., voice mean opinion score (MOS) value derived from measured voice packet delay, jitter, error rate; services type(s) defining a subset of services needed to be measured; a measurement triggering configuration of supporting event-based and time-based QoE measurement triggering.

In an embodiment, the RAN visible QoE configuration comprises at least one of the following information: an RAN visible QoE metric defining a subset of QoE measured data collected from UE which are useful for RAN (e.g. packet Round-trip time, jitter duration time, throughput, . . . , etc.; QoE visible values, defining a subset of QoE values derived from the QoE metrics data which are useful for the RAN node (e.g., voice MOS value derived from measured voice packet delay, jitter, error rate; service type(s) defining a subset of services needed to be measured; a measurement triggering configuration, configured to support event-based and time-based QoE measurement triggering.

In an embodiment, the MN is able to configure one of the RAN visible QoE configuration and the QoE configuration container when receiving another one of the RAN visible QoE configuration and the QoE configuration container. For example, the MN may receive the QoE configuration container sent by the CN and configure the RAN visible QoE configuration by the OAM.

In step 102, if the RAN visible QoE is allowed (e.g., receiving the RAN visible QoE allowed indication or the RAN visible QoE is predefined to be allowed), the MN decides whether to activate the RAN visible QoE function. The MN also needs to decide to allocate QoE report resources at the MN or the SN for QoE report(s). In this embodiment, the MN activates the RAN visible QoE.

In an embodiment, the MN allocates radio bearer resources at the MN for the QoE report(s). As an alternative or in addition, the MN sends a QoE resource required indication within an XNAP/X2AP message (e.g., SN node addition request/SN node modification request, etc.) to SN to request SN to allocate radio bearer resource at SN for the QoE report(s).

In step 104, if the SN receives QoE resource required indication, the SN allocates QoE report resource at the SN.

In step 105, the MN receives QoE report resource information within an XNAP/X2AP message (e.g., SN node addition response/SN node modification response etc.) sent by SN, the QoE report resource information comprises the configuration of radio bearer resource locating at the SN for QoE report.

In steps 106 and 107, the MN assembles the RAN visible QoE and QoE container as QoE configuration information into a radio resource control (RRC) message. The RRC message may also include QoE report resource information, wherein the QoE report resource information comprises the configuration of radio bearer resource locating at the SN and/or the configuration of radio bearer resource locating at the MN.

In step 108, the UE saves received QoE configuration, activates and performs QoE measurement based on the QoE configuration information.

### Embodiment 2: QoE Activation Procedure (SN Configures Whole/Part QoE Configuration)

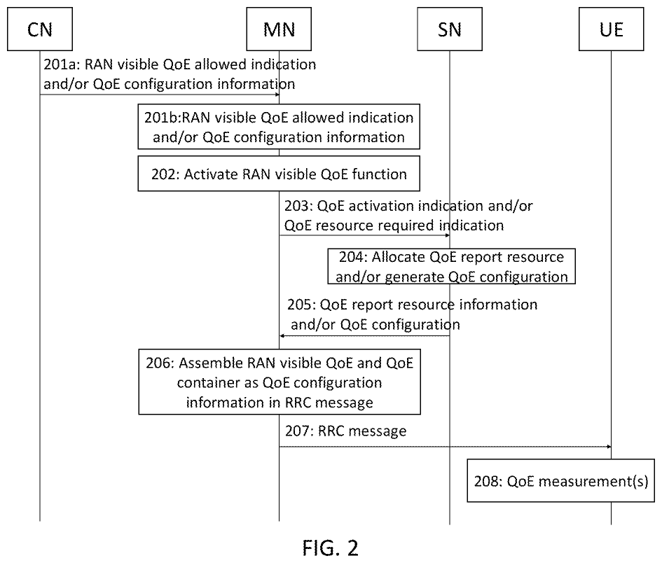

FIG. 2 shows a schematic diagram of a procedure according to an embodiment of the present disclosure. In FIG. 2, the MN receives the RAN visible QoE allowed indication from 5GC or OAM. As an alternative or in addition, the MN receives QoE configuration information from 5GC or OAM (steps 201a and 201b).

In an embodiment, the QoE configuration information comprises at least one of the following information: QoE configuration container, i.e. a coded container which is transparently forwarded by the RAN between UE and QoE server/CN/MCE and is not visible by the RAN node (i.e. MN or SN); RAN visible QoE configuration, which is visible by the RAN node.

In an embodiment, the QoE configuration container comprises at least one of the following information: a QoE metric defining a subset of QoE measured data collected from the UE (e.g. packet Round-trip time, jitter duration time, throughput, . . . , etc.); QoE values defining define a subset of QoE values derived from the QoE metrics data (e.g., voice MOS value derived from measured voice packet delay, jitter, error rate; services type(s) defining a subset of services needed to be measured; a measurement triggering configuration of supporting event-based and time-based QoE measurement triggering.

In an embodiment, the RAN visible QoE configuration comprises at least one of the following information: an RAN visible QoE metric defining a subset of QoE measured data collected from UE which are useful for RAN (e.g. packet Round-trip time, jitter duration time, throughput, . . . , etc.; QoE visible values, defining a subset of QoE values derived from the QoE metrics data which are useful for the RAN node (e.g., voice MOS value derived from measured voice packet delay, jitter, error rate; service type(s) defining a subset of services needed to be measured; a measurement triggering configuration, configured to support event-based and time-based QoE measurement triggering.

In step 202, if the RAN visible QoE is allowed, MN decides whether to activate the RAN visible QoE function. The MN may also need to decide to allocate QoE report resources at the MN or the SN.

In step 203, the MN configure QoE activation indication, to indicate to active all configured QoE configuration or to activate RAN visible QoE configuration and/or to activate the QoE configuration container. For example, if the MN receives no QoE configuration from the CN or the OAM, the MN sets the QoE activation indication as ‘activate all configured QoE configuration’ to request both the QoE configuration container and the RAN visible QoE configuration generated by the SN. As an alternative, if the MN receives only the QoE configuration container from the CN or the OAM and the RAN visible QoE (measurement/report) is allowed, the MN sends the QoE activation indication indicating ‘activate RAN visible QoE configuration’ to request the RAN visible QoE configuration generated by the SN. In an embodiment, if the MN receives only the RAN visible QoE configuration from the CN or the OAM, the MN set the QoE activation indication as ‘activate QoE configuration container’ to request the RAN configuration container generated by the SN.

In an embodiment, the MN allocates radio bearer resources at the MN for the QoE report. As an alternative or in addition, the MN transmits a QoE resource required indication to the SN (e.g., in step 103), to request the SN to allocate radio bearer resources at the SN for the QoE report.

In an embodiment, the MN send an XNAP/X2AP message (e.g., SN node addition request, SN node modification request, . . . , etc.) to the SN, wherein the QoE resource required indication and/or the QoE activation indication is included in this XNAP/X2AP message.

In step 204, if the SN receives QoE resource required indication, the SN (shall) allocates the QoE report resources at the SN. As an alternative or in addition, if receiving the QoE activation indication, the SN generates the QoE configuration by the OAM.

In step 205, the MN receives the QoE report resource information and/or the QoE configuration generated at the SN within an XNAP/X2AP message (e.g., SN node addition response/SN node modification response, . . . , etc.) from the SN The QoE report resource information may comprise the configuration of radio bearer resource locating at the SN for the QoE report. In addition, the QoE configuration information may comprise at least one of the following information: QoE configuration container generated by the SN, RAN visible QoE configuration generated by the SN.

In step 206 and 207, the MN assembles the RAN visible QoE and the QoE container as the QoE configuration information into an RRC message. In an embodiment, the message may also include the QoE report resource information comprising the configuration of radio bearer resource locating at the SN and/or the configuration of radio bearer resource locating at the MN.

In step 208, the UE saves received QoE configuration, activates and performs QoE measurement(s) based on the received QoE configuration (information).

### Embodiment 3: QoE Deactivation Procedure (MN Trigger)

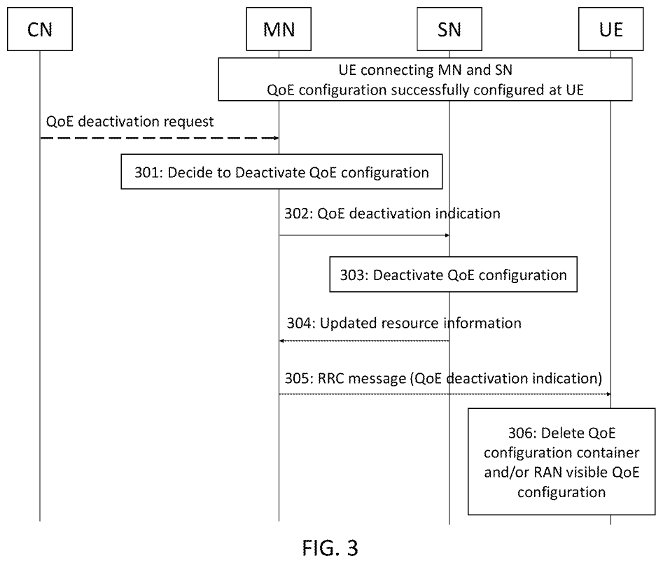

FIG. 3 shows a schematic diagram of a procedure according to an embodiment of the present disclosure. In FIG. 3, the UE connects to the MN and the SN and the QoE configuration (e.g., QoE configuration container and/or RAN visible QoE configuration) is successfully configured at the UE.

In step 301, the MN decides to deactivate QoE configuration. For example, if MN receives QoE container deactivation request from the CN or the OAM, the MN may make a decision to deactivate the QoE configuration container, or to deactivate all QoE configuration including the QoE configuration container and the RAN visible QoE configuration. As an alternative or in addition, if the MN and/or the SN is overload, the MN may decide to deactivate only the RAN visible QoE configuration.

In an embodiment, if the whole QoE (i.e. both QoE configuration container and the RAN visible QoE configuration) needs to be deactivated and the QoE report resource(s) is allocated at the MN, the MN may release the QoE report resource(s) at the MN.

In step 302, if the QoE configuration towards UE is generated by the SN, the MN sends a QoE deactivation indication (e.g. indicating ‘deactivate all configured QoE configuration’) to the SN, to deactivate both the QoE configuration container (if configured) and the RAN visible QoE configuration (if configured). The SN may delete all configured QoE configuration(s) for the UE at the SN. In an embodiment, if only the RAN visible QoE configuration towards UE is generated by the SN, MN sends a QoE deactivation indication indicating ‘deactivate RAN visible QoE configuration’ to the SN, to deactivate the RAN visible QoE configuration. The SN may delete RAN visible QoE configuration for the UE at the SN. In an embodiment, if only the QoE configuration container towards UE is generated by the SN, the MN sends a QoE deactivation indication indicating ‘ deactivate QoE configuration container’ to the SN, to deactivate the RAN visible configuration. The SN may delete the RAN visible QoE configuration for the UE at the SN.

In step 303, the SN deactivate QoE configuration according to the received QoE deactivation indication. In an embodiment of whole QoE configuration being deactivated and the QoE report resource(s) being allocated at the SN, the SN may release the QoE report resource(s) at the SN.

In step 304, the MN may receive updated radio bearer resource information at the SN within an XNAP/X2AP message (e.g., SN node addition response/SN node modification response, . . . , etc.) from the SN, in the case of the SN releases the QoE report resource(s) at the SN.

In step 305, the MN generates and send an RRC message UE to deactivate the QoE measurement(s)/report(s) for the QoE configuration container and/or the RAN visible QoE configuration at the UE. The RRC message comprises at least one of the following information: updated MN/SN radio bearer information; QoE deactivation indication

In an embodiment, the QoE deactivation indication indicates ‘deactivate all configured QoE configuration’ and denotes deactivating both the QoE configuration container (if configured) and the RAN visible QoE configuration (if configured). In this embodiment, the UE may delete all configured QoE configurations at the UE.

In an embodiment, the QoE deactivation indication indicates ‘deactivate RAN visible QoE configuration’ and denotes deactivating the RAN visible QoE configuration. In this embodiment, the UE may delete the RAN visible QoE configuration at UE.

In an embodiment, the QoE deactivation indication indicates ‘deactivate QoE configuration container’ and refers to deactivating RAN configuration container. The UE may accordingly delete the RAN visible QoE configuration at the UE.

In step 306, the UE delete the QoE configuration container and/or the RAN visible QoE configuration according to the received QoE deactivation indication and deactivates (e.g., stops) the corresponding QoE measurement(s) and report(s).

### Embodiment 4: QoE Deactivation Procedure (SN Trigger)

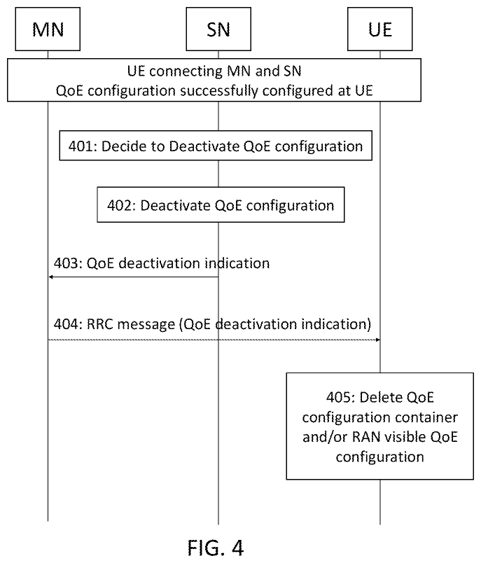

FIG. 4 shows a schematic diagram of a procedure according to an embodiment of the present disclosure. In FIG. 4, the UE connects to the MN and the SN and the QoE configuration (e.g., QoE configuration container and/or RAN visible QoE configuration) is successfully configured at the UE.

In step 401, the SN decides to deactivate the QoE configuration (e.g., QoE configuration container and/or RAN visible QoE configuration). For example, if the QoE configuration container towards the UE is generated by the SN, the SN may decide to deactivate the QoE configuration container. As an alternative or in addition, if the RAN visible QoE configuration towards the UE is generated by the SN, the SN may decide to deactivate the RAN visible QoE configuration.

In step 402 (optional), the SN deactivates the QoE configuration at the SN according to decision. In an embodiment of the whole configured QoE configuration(s) being deactivated and the related QoE report resource being allocated at the SN, the SN may release the QoE report resource at the SN.

In step 403, the MN may receive a QoE deactivation indication within an XNAP/X2AP message (e.g., SN node addition response, SN node modification response, etc.) from the SN. In an embodiment, the MN may also receive updated radio bearer resource information at the SN within the same message if the SN releases the QoE report resource(s) at the SN.

In an embodiment, the MN receives the QoE deactivation indication indicating ‘deactivate all configured QoE configurations’ from the SN for deactivating both QoE configuration container (if configured) and the RAN visible QoE configuration (if configured). In this embodiment, the MN may delete all configured QoE configurations at the MN for the UE.

In an embodiment, the MN receives the QoE deactivation indication indicating ‘deactivate RAN visible QoE configuration’ from the SN for deactivating the RAN visible QoE configuration, the MN may delete the RAN visible QoE configuration at the MN for the UE.

In an embodiment, the MN receives the QoE deactivation indication indicating ‘deactivate QoE configuration container’ from the SN for deactivating the RAN configuration container, the MN may delete the RAN visible QoE configuration at the MN for the UE.

In an embodiment, if whole QoE configurations are deactivated and QoE report resource(s) is allocated at the MN, the MN may release QoE report resource at the MN.

In step 404, the MN generates and send an RRC message UE to deactivate QoE measurement(s)/report(s) for the QoE configuration container and/or the RAN visible QoE configuration at the UE. The RRC message may comprise at least one of the following information: updated MN/SN radio bearer information; QoE deactivation indication.

In an embodiment, the QoE deactivation indication indicates ‘deactivate all configured QoE configuration’ and denotes deactivating both the QoE configuration container (if configured) and the RAN visible QoE configuration (if configured). In this embodiment, the UE may delete all configured QoE configurations at the UE.

In an embodiment, the QoE deactivation indication indicates ‘deactivate RAN visible QoE configuration’ and denotes deactivating the RAN visible QoE configuration. In this embodiment, the UE may delete the RAN visible QoE configuration at UE.

In an embodiment, the QoE deactivation indication indicates ‘deactivate QoE configuration container’ and refers to deactivating RAN configuration container. The UE may accordingly delete the RAN visible QoE configuration at the UE.

In step 405, the UE deletes QoE container and/or RAN visible QoE configuration according to the received QoE deactivation indication and deactivates (e.g., stops) the corresponding QoE measurement and reporting.

### Embodiment 5: QoE Suspend/Resume Procedure (MN Trigger)

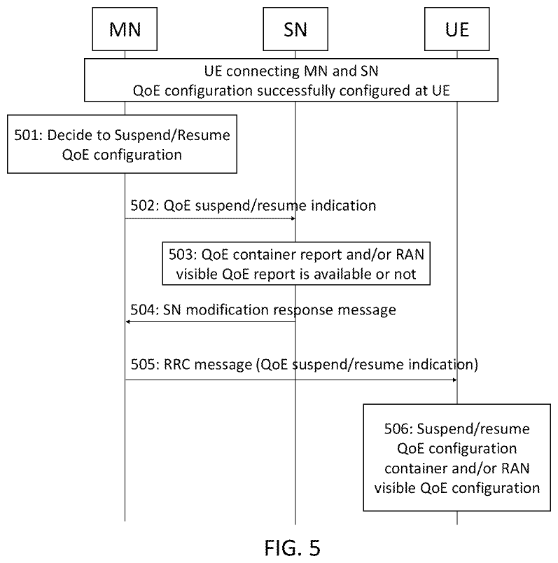

FIG. 5 shows a schematic diagram of a procedure according to an embodiment of the present disclosure. In FIG. 5, the UE connects to the MN and the SN and the QoE configuration (e.g., QoE configuration container and/or RAN visible QoE configuration) is successfully configured at the UE.

In step 501, the MN decides to suspend/resume the QoE configuration. For example, if the MN and/or the SN is overload, the MN may decide to suspend (e.g., pause) the RAN visible QoE configuration and/or the QoE configuration container. As an alternative or in addition, if the load of the MN and/or the SN is deduced, the MN may determine to resume (e.g., start) the RAN visible QoE configuration and/or the QoE configuration container.

In step 502, based on the decision, the MN may send a QoE suspend/resume indication indicating ‘suspend/resume all configured QoE configuration’ to the SN, to suspend/resume both the QoE configuration container(if configured) and the RAN visible QoE configuration(if configured). In an embodiment, the MN may send a QoE suspend/resume indication indicating ‘suspend/resume RAN visible QoE configuration’ to the SN, to suspend/resume the RAN visible QoE configuration. In an embodiment, the MN may send a QoE suspend/resume indication indicating ‘suspend/resume QoE configuration container’ to the SN, to suspend/resume the RAN visible QoE configuration.

In step 503, according to the received suspend/resume indication, the SN is aware of that the QoE container report and/or the RAN visible QoE report is available or not

In step 504, the SN send an SN modification response message to the MN.

In step 505, the MN generates and sends an RRC message to the UE, to suspend/resume QoE measurement(s)/report(s) for the QoE configuration container and/or the RAN visible QoE configuration at the UE. The RRC message comprises the QoE suspend/resume indication.

In an embodiment, the QoE suspend/resume indication indicates ‘suspend/resume all configured QoE configuration’ and denotes suspending/resuming both the QoE configuration container (if configured) and the RAN visible QoE configuration (if configured).

In an embodiment, the QoE suspend/resume indication indicates ‘suspend or resume RAN visible QoE configuration’ and denotes suspending/resuming the RAN visible QoE configuration.

In an embodiment, the QoE suspend/resume indication indicates ‘suspend/resume QoE configuration container’ and denotes suspending/resuming the RAN visible QoE configuration.

In step 506, the UE receives suspend/resume indication. The UE resumes/suspends (e.g., starts/pauses) the corresponding QoE measurement(s) and report(s).

### Embodiment 6: QoE Suspend/Resume Procedure (SN Trigger)

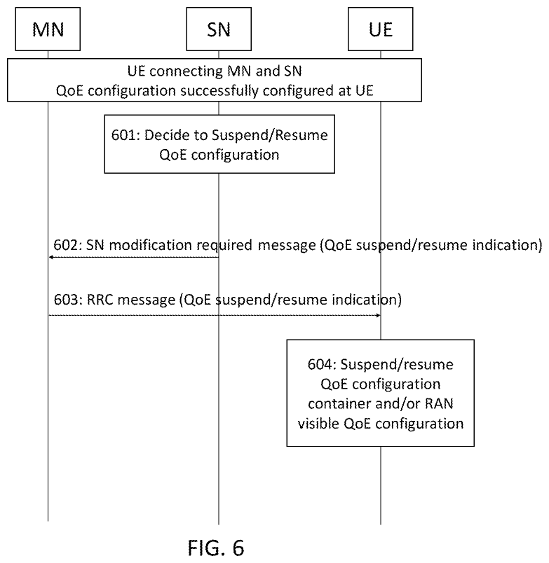

FIG. 6 shows a schematic diagram of a procedure according to an embodiment of the present disclosure. In FIG. 6, the UE connects to the MN and the SN and the QoE configuration (e.g., QoE configuration container and/or RAN visible QoE configuration) is successfully configured at the UE.

In step 601, the SN decides to suspend/resume the QoE configuration. For example, when all QoE configuration generated by the SN and SN is overload, the SN may decide to suspend(pause) the RAN visible QoE configuration and/or the QoE configuration container. As an alternative or in addition, when the load of the SN is deduced, the SN may determine to resume(start) the RAN visible QoE configuration and/or the QoE configuration container.

In step 602, based on the decision, the SN may send a QoE suspend/resume indication indicating ‘suspend/resume all configured QoE configuration’ to the MN, to suspend/resume both the QoE configuration container(if configured) and the RAN visible QoE configuration (if configured). In an embodiment, the SN may send the QoE suspend/resume indication indicating ‘suspend/resume RAN visible QoE configuration’ to the MN, to suspend/resume RAN visible QoE configuration. In an embodiment, the SN may send a QoE suspend/resume indication indicating ‘suspend/resume QoE configuration container’ to the MN, to suspend/resume the RAN visible QoE configuration.

In step 603, the MN generates and sends an RRC message to the UE, to suspend/resume QoE measurement(s)/report(s) for the QoE configuration container and/or RAN visible QoE configuration at the UE.

The RRC message comprises the QoE suspend/resume indication.

In an embodiment, the QoE suspend/resume indication indicates ‘suspend/resume all configured QoE configuration’ and denotes suspending/resuming both the QoE configuration container (if configured) and the RAN visible QoE configuration (if configured).

In an embodiment, the QoE suspend/resume indication indicates ‘suspend or resume RAN visible QoE configuration’ and denotes suspending/resuming the RAN visible QoE configuration

In an embodiment, the QoE suspend/resume indication indicates ‘suspend/resume QoE configuration container’ and denotes suspending/resuming the RAN visible QoE configuration.

In step 604, based on the received suspend/resume indication, the UE suspends/resumes (e.g., pauses/starts) the corresponding QoE measurement(s) and report(s).

### Embodiment 7: QoE Report (QoE Report Resource Configured at MN)

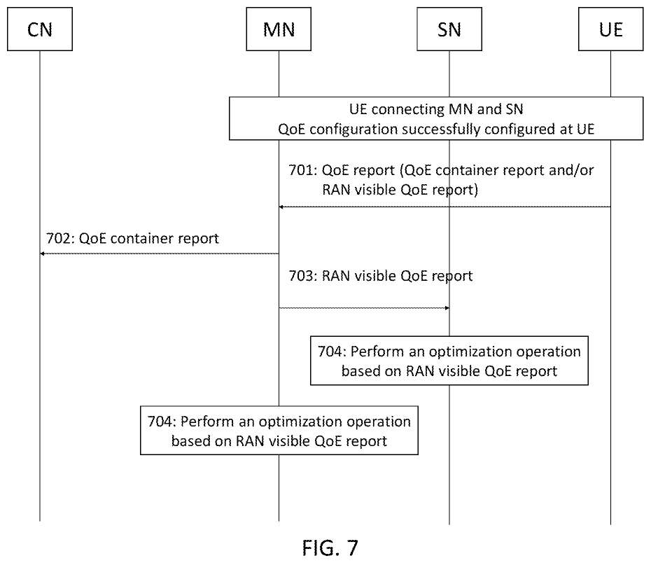

FIG. 7 shows a schematic diagram of a procedure according to an embodiment of the present disclosure. In FIG. 7, the UE connects to the MN and the SN and the QoE configuration (e.g., QoE configuration container and/or RAN visible QoE configuration) is successfully configured at the UE. In this embodiment, the QoE report resource is configured (e.g., allocated) at the MN.

In step 701, the UE sends QoE report(s) including QoE container report(s) and/or RAN visible QoE report(s) to the MN based on the QoE report resource locating at the MN.

In step 702, if the received QoE report(s) includes the QoE container report(s), the MN forwards the received QoE container report(s) to the CN (e.g. a QoE server and/or a CN entity).

In step 703, if the received QoE report(s) includes the RAN visible QoE report(s), the MN forwards the RAN visible QoE report(s) to the SN.

In step 704, the MN and SN uses RAN visible QoE report to perform an optimization operation, such as monitoring transmission quality, optimizing scheduling, . . . , etc.

### Embodiment 8: QoE Report (QoE Report Resource Configured at SN)

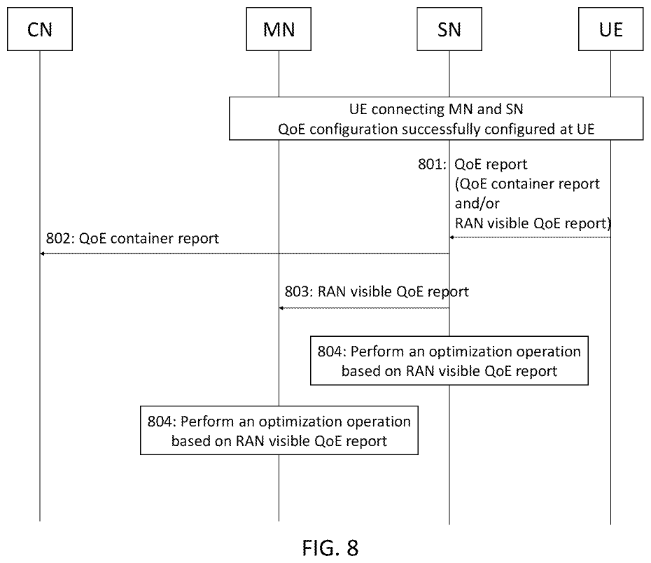

FIG. 8 shows a schematic diagram of a procedure according to an embodiment of the present disclosure. In FIG. 8, the UE connects to the MN and the SN and the QoE configuration (e.g., QoE configuration container and/or RAN visible QoE configuration) is successfully configured at the UE. In this embodiment, the QoE report resource(s) is configured (e.g., allocated) at the SN.

In step 801, the UE sends QoE report(s) including QoE container report(s) and/or RAN visible QoE report(s) to the SN based on the QoE report resources locating at SN.

In step 802, if the received QoE report(s) including the QoE container report(s), the SN forwards the QoE container report(s) to the CN (e.g., a QoE server and/or a CN entity).

In step 803, when the received QoE report(s) includes the RAN visible QoE report(s), the SN forwards the RAN visible QoE report(s) to the MN.

In step 804, the MN and SN may use the RAN visible QoE report(s) to perform an optimization operation, such as monitoring transmission quality, optimizing scheduling, . . . , etc.

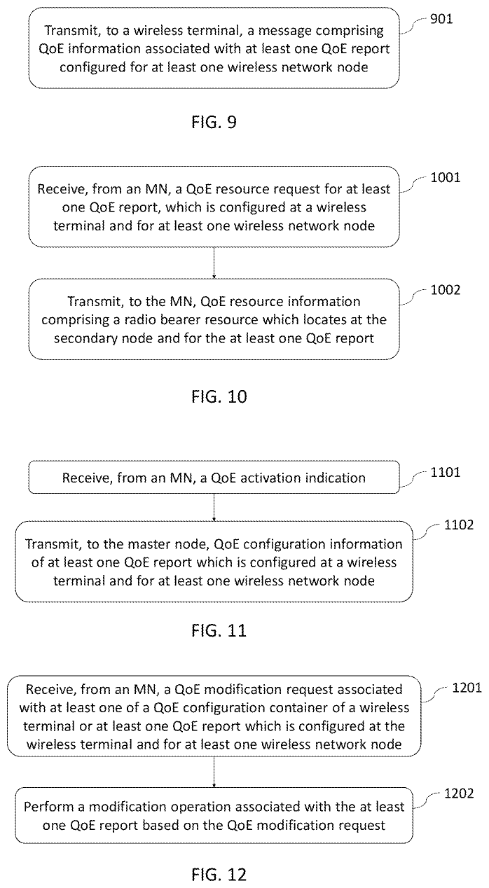

FIG. 9 shows a flowchart of a method according to an embodiment of the present disclosure. The method shown in FIG. 9 may be used in an MN (e.g., RAN node or BS) and comprises the following step:

Step 901: Transmitting, to a wireless terminal, a message comprising QoE information associated with at least one QoE report configured for at least one wireless network node.

In this embodiment, the MN may transmits a message (e.g., RRC message) comprising QoE information to a wireless terminal (e.g. UE), wherein the QoE information is associated with at least one QoE report (measurement) configured for at least one wireless network node (e.g. MN and/or SN connected to the UE via the DC). That is, the QoE information may comprise QoE configuration information and/or QoE report resource information which is associated with at least one QoE report. Note that, the QoE configuration information is visible to the MN and/or SN, thus the MN and/or SN is able to acknowledge and understand the at least one QoE report. Under such a condition, the MN and/or SN is able to make use of the at least one QoE report (e.g., perform an optimization on scheduling or for improving service quality).

In an embodiment, the QoE information comprises QoE report resource information comprising at least one of a radio bearer resource located at the master node or a radio bearer resource located at a secondary node connected to the wireless terminal. That is, the QoE report resource may be allocated at the MN and/or SN.

In an embodiment, QoE information comprises QoE configuration information of the at least one QoE report. For example, the QoE configuration information comprises at least one of:
at least one QoE metric, associated with a subset of QoE data measured for the at least one QoE report,
at least one QoE value derived based on the at least one QoE metric;
at least one services type associated with the at least one QoE report; or
at least one measurement triggering configuration of the at least one QoE report.

In an embodiment, the QoE information comprises QoE status indication information comprising one of:
a QoE activation indication of activating the at least one QoE report;
a QoE deactivation indication of deactivating the at least one QoE report,
a QoE suspend indication of suspending the at least one QoE report, or
a QoE resume indication of resuming the at least one QoE report.

In an embodiment, the MN may receive at least one of a QoE allowed indication or a transparent QoE container configured by the core network or the OAM function for the wireless terminal from the CN or the OAM (function). After receiving at least one of the QoE allowed indication or the transparent QoE container, the MN is able to determine whether to enable the QoE report which is visible to the MN and/or SN.

In an embodiment, the MN may allocate the QoE resource information comprising a radio bearer resource for the at least one QoE report itself (i.e. the QoE resource locates at the MN). The QoE resource information is (transmitted) in the QoE information.

In an embodiment, the MN may transmit a QoE resource request for the at least one QoE report and receive QoE resource information comprising a radio bearer resource which locates at the secondary node for the at least one QoE report. The QoE resource information is (transmitted) in the QoE information. That is, the QoE report resource locates at the SN.

In an embodiment, the MN may transmit a QoE activation indication to the SN and receive QoE configuration information for the at least one QoE report from the SN.

In an embodiment, the MN may receive a deactivation request for at least one of a QoE configuration container of the wireless terminal or the at least one QoE report from the OAM function. Based on the deactivation request, the MN may transmit, to the SN, a QoE modification request comprising a QoE deactivation indication for at least one of the QoE configuration container of the wireless terminal or the at least one QoE report, e.g., to deactivate the at least one QoE report.

In an embodiment, the MN may receive, from the SN, a QoE required message comprising a QoE deactivation indication for at least one of a QoE configuration container of the wireless terminal or the at least one QoE report. Based on the QoE deactivation indication, the MN may deactivate the at least one QoE report.

In an embodiment, the MN may transmit a QoE modification request to the SN, wherein the QoE modification request comprises at least one of: a QoE suspend indication for at least one of a QoE configuration container of the wireless terminal or the at least one QoE report, or a QoE resume indication for at least one of the QoE configuration container of the wireless terminal or the at least one QoE report.

In an embodiment, the MN may receive a QoE modification required message from the SN, wherein the QoE modification required message comprises at least one of: a QoE suspend indication for at least one of a QoE configuration container of the wireless terminal or the at least one QoE report, or a QoE resume indication for at least one of the QoE configuration container of the wireless terminal or the at least one QoE report.

In an embodiment, the MN may receive the at least one QoE report from the wireless terminal. Based on the at least one QoE report which is visible to the MN, the MN may perform the optimization, so as to provide greater service quality. In this embodiment, the MN may transmit the at least one QoE report to the SN.

In an embodiment, the MN may receive the at least one QoE report from the SN.

FIG. 10 shows a schematic diagram of a method according to an embodiment of the present disclosure. The method shown in FIG. 10 may be used in an SN and comprises the following steps:

Step 1001: Receive, from an MN, a QoE resource request for at least one QoE report, which is configured at a wireless terminal and for at least one wireless network node.

Step 1002: Transmit, to the MN, QoE resource information comprising a radio bearer resource which locates at the secondary node and for the at least one QoE report.

In this embodiment, the SN may receive a QoE resource request for at least one QoE report from the MN, to acquire QoE resource information from the SN. The at least one QoE report is configured at a wireless terminal (e.g., UE) and for at least one wireless network node (e.g., MN and/or SN). That is, the at least one QoE report is visible to the MN and/or SN. In response to the QoE resource request, the SN allocates the QoE radio bearer resource locating at the SN and transmits the QoE resource information comprising the allocated radio bearer resource to the MN. Note that, the MN and the SN are connected to the wireless terminal via the DC.

FIG. 11 shows a schematic diagram of a method according to an embodiment of the present disclosure. The method shown in FIG. 11 may be used in an SN and comprises the following steps:

Step 1101: Receive, from an MN, a QoE activation indication.

Step 1102: Transmit, to the master node, QoE configuration information of at least one QoE report which is configured at a wireless terminal and for at least one wireless network node.

In FIG. 11, the SN may receive a QoE activation indication from an MN. In response to the QoE activation indication, the Sn transmits QoE configuration information of at least one QoE report which is configured at a wireless terminal (e.g., UE) and for at least one wireless network node. In this embodiment, the MN and the SN are connected to the wireless terminal via the DC.

FIG. 12 shows a schematic diagram of a method according to an embodiment of the present disclosure. The method shown in FIG. 12 may be used in an SN and comprises the following steps:

Step 1201: Receive, from an MN, a QoE modification request associated with at least one of a QoE configuration container of a wireless terminal or at least one QoE report which is configured at the wireless terminal and for at least one wireless network node.

Step 1202: Perform a modification operation associated with the at least one QoE report based on the QoE modification request.

In FIG. 12, the SN receives a QoE modification request from the MN. The QoE modification request may be associated with at least one of: a QoE configuration container of a wireless terminal or at least one QoE report which is configured at the wireless terminal and for at least one wireless network node (i.e. visible to the MN and/or SN). According to the QoE modification request, the SN perform a modification operation associated with the at least one QoE report. For example, the QoE modification request comprises at least one of: a QoE deactivation indication, a QoE suspend indication, or a QoE resume indication. That is, the SN may deactivate/suspend/resume the at least one QoE report. In this embodiment, the MN and the SN are connected to the wireless terminal via the DC.

In an embodiment, if the report resource of the at least one QoE report locates at the SN, the SN may modify (e.g., release) the report resource if receiving the QoE deactivation indication and transmits updated resource information to the MN.

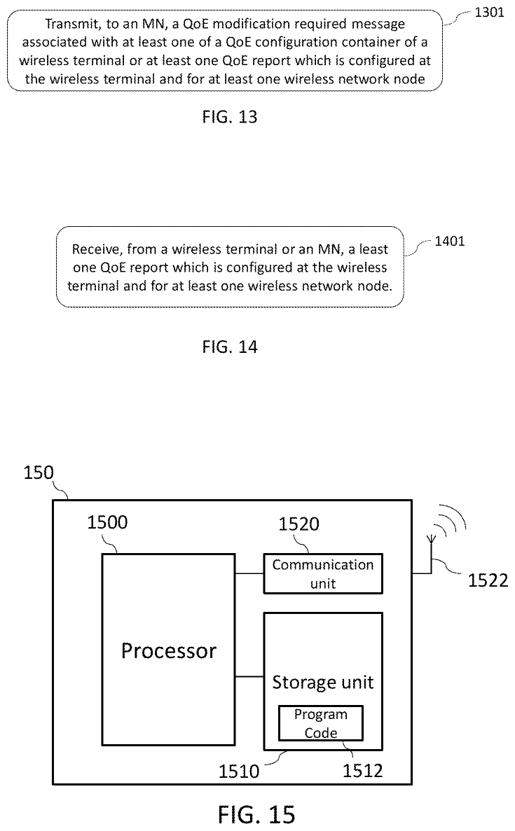

FIG. 13 shows a schematic diagram of a method according to an embodiment of the present disclosure. The method shown in FIG. 13 may be used in an SN and comprises the following step:

Step 1301: Transmit, to an MN, a QoE modification required message associated with at least one of a QoE configuration container of a wireless terminal or at least one QoE report which is configured at the wireless terminal and for at least one wireless network node.

In this embodiment, the SN may transmit a QoE modification required message to an MN. The QoE modification required message is associated with at least one of a QoE configuration container of a wireless terminal or at least one QoE report which is configured at the wireless terminal and for at least one wireless network node (i.e., visible to the MN and/or SN). For instance, the QoE modification required message comprises at least one of: a QoE deactivation indication, a QoE suspend indication, or a QoE resume indication. That is, the at least one QoE report may be deactivated/resumed/suspended at the MN and the SN. In this embodiment, the MN and the SN are connected to the wireless terminal via the DC.

FIG. 14 shows a schematic diagram of a method according to an embodiment of the present disclosure. The method shown in FIG. 10 may be used in an SN and comprises the following step:

Step 1401: Receive, from a wireless terminal or an MN, a least one QoE report which is configured at the wireless terminal and for at least one wireless network node.

In FIG. 14, the SN receives a least one QoE report directly from the wireless terminal (e.g., UE) or from the MN. The at least one QoE report is configured at the wireless terminal and for at least one wireless network node (i.e., visible to the MN and/or SN). In this embodiment, the MN and the SN are connected to the wireless terminal via the DC.

FIG. 15 relates to a schematic diagram of a wireless terminal 150 according to an embodiment of the present disclosure. The wireless terminal 150 may be a user equipment (UE), a mobile phone, a laptop, a tablet computer, an electronic book or a portable computer system and is not limited herein. The wireless terminal 150 may include a processor 1500 such as a microprocessor or Application Specific Integrated Circuit (ASIC), a storage unit 1510 and a communication unit 1520. The storage unit 1510 may be any data storage device that stores a program code 1512, which is accessed and executed by the processor 1500. Embodiments of the storage unit 1512 include but are not limited to a subscriber identity module (SIM), read-only memory (ROM), flash memory, random-access memory (RAM), hard-disk, and optical data storage device. The communication unit 1520 may a transceiver and is used to transmit and receive signals (e.g., messages or packets) according to processing results of the processor 1500. In an embodiment, the communication unit 1520 transmits and receives the signals via at least one antenna 1522 shown in FIG. 15.

In an embodiment, the storage unit 1510 and the program code 1512 may be omitted and the processor 1500 may include a storage unit with stored program code.

The processor 1500 may implement any one of the steps in exemplified embodiments on the wireless terminal 150, e.g., by executing the program code 1512.

The communication unit 1520 may be a transceiver. The communication unit 1520 may as an alternative or in addition be combining a transmitting unit and a receiving unit configured to transmit and to receive, respectively, signals to and from a wireless network node (e.g., a base station).

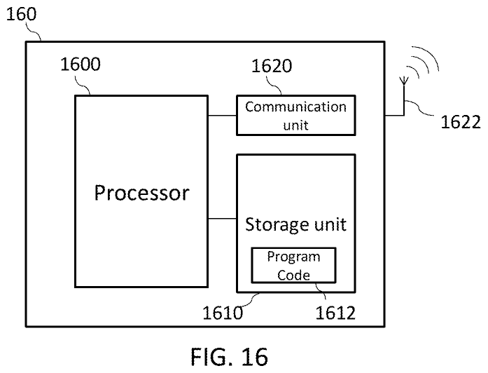

FIG. 16 relates to a schematic diagram of a wireless network node 160 according to an embodiment of the present disclosure. The wireless network node 160 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 160 may comprise (perform) at least one network function such as an access and mobility management function (AMF), a session management function (SMF), a user place function (UPF), a policy control function (PCF), an application function (AF), etc. The wireless network node 160 may include a processor 1600 such as a microprocessor or ASIC, a storage unit 1610 and a communication unit 1620. The storage unit 1610 may be any data storage device that stores a program code 1612, which is accessed and executed by the processor 1600. Examples of the storage unit 1612 include but are not limited to a SIM, ROM, flash memory, RAM, hard-disk, and optical data storage device. The communication unit 1620 may be a transceiver and is used to transmit and receive signals (e.g., messages or packets) according to processing results of the processor 1600. In an example, the communication unit 1620 transmits and receives the signals via at least one antenna 1622 shown in FIG. 16.

In an embodiment, the storage unit 1610 and the program code 1612 may be omitted. The processor 1600 may include a storage unit with stored program code.

The processor 1600 may implement any steps described in exemplified embodiments on the wireless network node 160, e.g., via executing the program code 1612.

The communication unit 1620 may be a transceiver. The communication unit 1620 may as an alternative or in addition be combining a transmitting unit and a receiving unit configured to transmit and to receive, respectively, signals to and from a wireless terminal (e.g. a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

We claim:

1. A wireless communication method for use in a master node, the method comprising:
transmitting, to a wireless terminal, a message comprising quality of experience (QoE) information associated with at least one QoE report visible to at least one wireless network node.

2. The wireless communication method of claim 1, wherein the QoE information comprises QoE report resource information comprising at least one of a radio bearer resource located at the master node or a radio bearer resource located at a secondary node connected to the wireless terminal.

3. The wireless communication method of claim 1, wherein the QoE information comprises QoE configuration information of the at least one QoE report,
wherein the QoE configuration information comprises at least one of:
at least one QoE metric, associated with a subset of QoE data measured for the at least one QoE report,
at least one QoE value derived based on the at least one QoE metric;
at least one services type associated with the at least one QoE report; or
at least one measurement triggering configuration of the at least one QoE report.

4. The wireless communication method of claim 1, wherein the QoE information comprises QoE status indication information comprising one of:
a QoE activation indication of activating the at least one QoE report;
a QoE deactivation indication of deactivating the at least one QoE report,
a QoE suspend indication of suspending the at least one QoE report, or
a QoE resume indication of resuming the at least one QoE report.

5. The wireless communication method of claim 1, further comprising:
receiving, from a core network or an operations, administration and maintenance (OAM) function, at least one of a QoE allowed indication or a transparent QoE container configured by the core network or the OAM function for the wireless terminal.

6. The wireless communication method of claim 5, further comprising:
allocating QoE resource information comprising a radio bearer resource for the at least one QoE report,
wherein the QoE information comprises the radio bearer resource for the at least one QoE report.

7. The wireless communication method of claim 5, further comprising:
transmitting, to a secondary node connected to the wireless terminal, a QoE resource request for the at least one QoE report, and
receiving, from the secondary node, QoE resource information comprising a radio bearer resource which locates at the secondary node for the at least one QoE report,
wherein the QoE information comprises the QoE resource information.

8. The wireless communication method claim 5, further comprising:
transmitting, to a secondary node connected to the wireless terminal, a QoE activation indication, and
receiving, from the secondary node, QoE configuration information comprised in the QoE information.

9. The wireless communication method of claim 1, further comprising:
receiving, from a core network or an OAM function, a deactivation request for at least one of a QoE configuration container of the wireless terminal or the at least one QoE report.

10. The wireless communication method of claim 9, further comprising:
transmitting, to a secondary node connected to the wireless terminal, a QoE modification request comprising a QoE deactivation indication for at least one of the QoE configuration container of the wireless terminal or the at least one QoE report.

11. The wireless communication method of claim 1, further comprising:
receiving, from a secondary node connected to the wireless terminal, a QoE modification required message comprising a QoE deactivation indication for at least one of a QoE configuration container of the wireless terminal or the at least one QoE report.

12. The wireless communication method of claim 1, further comprising:
transmitting, to a secondary node connected to the wireless terminal, a QoE modification request,
wherein the QoE modification request comprises at least one of:
a QoE suspend indication for at least one of a QoE configuration container of the wireless terminal or the at least one QoE report, or
a QoE resume indication for at least one of the QoE configuration container of the wireless terminal or the at least one QoE report.

13. The wireless communication method of claim 1, further comprising:
receiving, from a secondary node connected to the wireless terminal, a QoE modification required message,
wherein the QoE modification required message comprises at least one of: a QoE suspend indication for at least one of a QoE configuration container of the wireless terminal or the at least one QoE report, or a QoE resume indication for at least one of the QoE configuration container of the wireless terminal or the at least one QoE report.

14. The wireless communication method of claim 1, further comprising:
receiving, from the wireless terminal, the at least one QoE report.

15. The wireless communication method of claim 14, further comprising:
transmitting, to a secondary node connected to the wireless terminal, the at least one QoE report.

16. The wireless communication method of claim 1, further comprising:
receiving, from a secondary node connected to the wireless terminal, the at least one QoE report.

17. A wireless communication method for use in a secondary node, the method comprising:
receiving, from a master node, a quality of experience (QoE) resource request for at least one QoE report, which is configured at a wireless terminal and for at least one wireless network node, and
transmitting, to the master node, QoE resource information comprising a radio bearer resource which locates at the secondary node and for the at least one QoE report,
wherein each of the master node and the secondary node is connected to the wireless terminal.

18. A master node, comprising a processor and a storage unit, wherein the processor is configured to read a program code from the storage unit and perform:
transmitting, to a wireless terminal, a message comprising quality of experience (QoE) information associated with at least one QoE report visible to at least one wireless network node.

19. The master node of claim 18, wherein the QoE information comprises QoE report resource information comprising at least one of a radio bearer resource located at the master node or a radio bearer resource located at a secondary node connected to the wireless terminal.

20. The master node of claim 18, wherein the QoE information comprises QoE configuration information of the at least one QoE report,
wherein the QoE configuration information comprises at least one of:
at least one QoE metric, associated with a subset of QoE data measured for the at least one QoE report,
at least one QoE value derived based on the at least one QoE metric;
at least one services type associated with the at least one QoE report; or
at least one measurement triggering configuration of the at least one QoE report.
